(19) United States
(12) Patent Application Publication
(10) Pub. No.: US 2006/0034206 A1
(43) Pub. Date: Feb. 16, 2006

(54) Method for determing the distance between two transmitting and receiving stations and transmitting and receiving stations for carrying out said method

(76) Inventors: Klaus Jacobi, Langenargen (DE); Maik Schaefer, Friedrichshafen-Kluftern (DE); Rolf Schuler, Salem (DE); Helmut Serr, Markdorf (DE); Peter Tolksdorf, Meersburg (DE)

Correspondence Address: FASSE PATENT ATTORNEYS, P.A., P.O. BOX 726, HAMPDEN, ME, 04444-0726, US

(21) Appl. No.: 10/530,914

(22) PCT Filed: Sep. 8, 2003
(86) PCT No.: PCT/DE03/02960

§ 371 Date: Apr. 8, 2005

(30) Foreign Application Priority Data
Oct. 12, 2002 (DE) 10247719.1

(51) Int. Cl. H04B 7/212

(52) U.S. Cl. 370/324; 370/503

(57) ABSTRACT

1. Method for determining the distance between two transmitting and receiving stations and transmitting and receiving stations for carrying out the method. 2.1. In automotive engineering transmitting and receiving stations are usually used in keyless locking systems as electronic key modules or evaluation units for identifying the key module. Deactivation of the locking system is prevented if the key module allocated by means of a clear identification number from the evaluation unit is not in the immediate vicinity of the evaluation unit. Communication between the evaluation unit and the key module is carried out by transmitting data telegrams between transmitting and receiving stations. The aim of the invention is to determine the distance between the transmitting and receiving stations in a simple manner. 2.2. According to the novel method, at least three data telegrams are alternately transmitted between the transmitting and receiving stations; when the data telegram is received, each data bit of said data telegram is associated with a counter value corresponding to the counter state of a free-running counter at the moment when the respective data bit is received; a counter sum is associated with each data telegram as a sum or average value of the counter values determined during reception of the data telegram concerned and a sum figure is formed by weighted summation of the counter sums as an indicator of the distance between the transmitting and receiving stations.

The invention relates to a method for determining the distance between two transmitting and receiving stations according to the preamble of patent claim 1. It further relates to an transmitting and receiving station for carrying out the method.

A method according to the preamble of patent claim 1 is known for example from DE 100 19 277 A1. In this method a radio link is established for transmitting data between an electronic key module to be carried by and on the user and an evaluation unit provided in a motor vehicle, in order to identify the key module based on an identification number stored in the key module, and to release, if necessary, the motor vehicle for use. The radio link is established here via a transmitting and receiving station provided in the key module and in the evaluation unit. To prevent the radio link from being extended via relay stations and to release the motor vehicle in this way without being noticed by the authorized user, the distance between the key module and the evaluation unit is determined and the release of the motor vehicle is prevented, if the key module is not within the immediate vicinity of the evaluation unit. In this case, determination of the distance is based on an evaluation of the signal running time of the signals transmitted via the radio link.

It is the object of the invention to indicate a method for determining the distance between two transmitting and receiving stations, which can be implemented at low expenditure and which is based on the evaluation of signals, which are usually used in motor vehicles in locking systems for the control of authorization for driving and gaining access. It is furthermore the object of the invention to indicate an transmitting and receiving station for carrying out the method.

The object is achieved by the features of patent claim 1, and by the features of patent claim 7. Advantageous developments and further embodiments of the invention become apparent from the further claims.

In accordance with the invention at least three data telegrams with at least one data bit each, preferably with the equal number of data bits, are alternately transmitted between the transmitting and receiving stations. When receiving the data telegrams a counter value corresponding to the counter state of a free-running counter is allocated to each data bit of the data telegram concerned at the time of the respective data bit and to each of the at least three data telegrams a counter sum is allocated as a sum or average value of the counter values determined during reception of the data telegram concerned. Subsequently, the counter sums are added by weighted summation to a sum figure, which is the indicator of the distance between the transmitting and receiving station.

Preferably, the counter sums with the weighted summation are each weighted each with a binominal coefficient corresponding to its sequence, the sequence of the counter sums being given by the sequence of the data telegrams, to which the counter sums are allocated respectively.

Preferably, information on the counter sums determined in the one transmitting and receiving station are transmitted to the respective other transmitting and receiving station as a component of a data telegram.

In a preferred embodiment of the method four data telegrams are evaluated for distance determination.

Advantageously, between the transmitted data telegrams a pause of a given duration is observed.

A transmitting and receiving station for implementing the method according to the invention comprises a transmitting and receiving antenna for receiving a received signal modulated preferably by amplitude keying and for transmitting a transmission signal modulated in same manner, a receiving arrangement for detecting data bits from the received signal, a transmitting arrangement for producing the transmission signal from a sequence of data bits to be transmitted, a time clocked in a given clock pulse for producing a bit timing corresponding to the time interval between successive counter state overflows, which bit timing determines the points in time at which the data bits to be transmitted are transmitted, and a register for taking over the counter state of the counter each at the point in time of receiving a data bit and for providing the assumed counter state as a counter value of the respective data bit.

Preferably, the transmitting and receiving station furthermore comprises a pulse width modulator clocked as per the indicator of the bit timing, which modulator produces from the data bits to be transmitted by pulse width modulation a binary transmission data signal, from which the transmitting arrangement itself produces the transmission signal.

Advantageously, the transmitting and receiving station comprises a switch, via which the transmitting and receiving antenna is conductively connected in accordance with the desired direction of transmission either with the receiving arrangement or with the transmitting arrangement.

Preferably, the transmitting and receiving station comprises a microcontroller for evaluating the determined counter values and for providing the data bits to be transmitted by the transmitting and receiving station.

The method according to the invention is particularly suitable for use in locking systems for the control of authorization for driving and gaining access for motor vehicles. With a locking system of this type data is exchanged between a base station provided in the motor vehicle and a portable key module, in order to test whether an authorization for gaining access and/or for driving is allocated to the key module and whether entrance to the motor vehicle or access to the motor vehicle, is to be granted or refused to the user of the key module corresponding to the present or non-present authorization for access or driving. The data transmission is effected via a radio link usually in so-called ISM-bands at 433 MHz or 868 MHz. In addition to the control for access and driving when exploiting equal radio bands the method according to the invention enables measurement of the distance between the key module and the base station. Here, distance resolutions of a few meters can be achieved.

By the distance measurement it is possible to refuse authorization for access and driving, if, in fact, an authorization for access and driving is allocated to the key module, however, however, its distance to the base station being such great that unauthorized persons can gather access to the motor vehicle without knowledge of the authorized user.

Hereinafter the invention is further explained by the examples of embodiment taken in conjunction with the drawings.

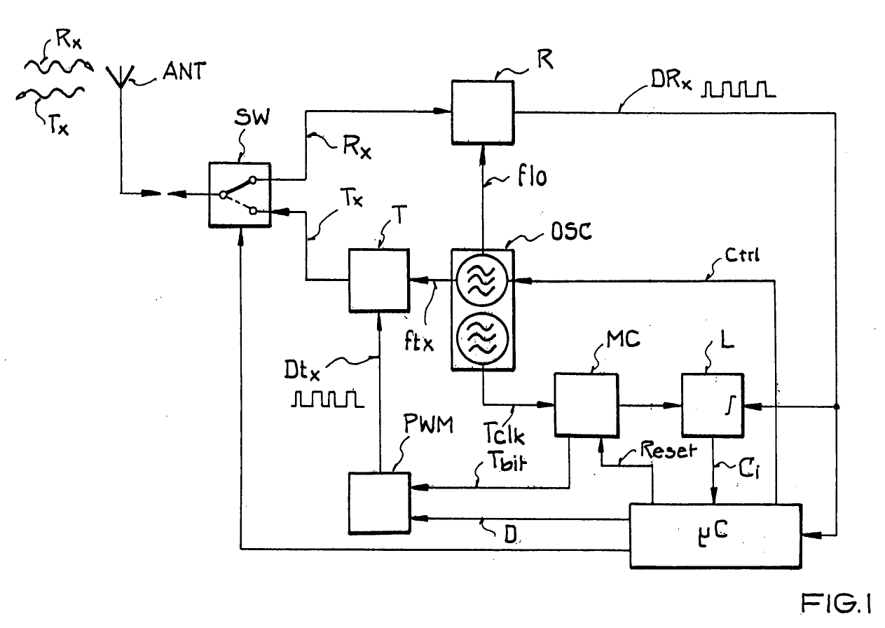

FIG. 1 shows a block diagram of a transmitting and receiving station for carrying out the method according to the invention,

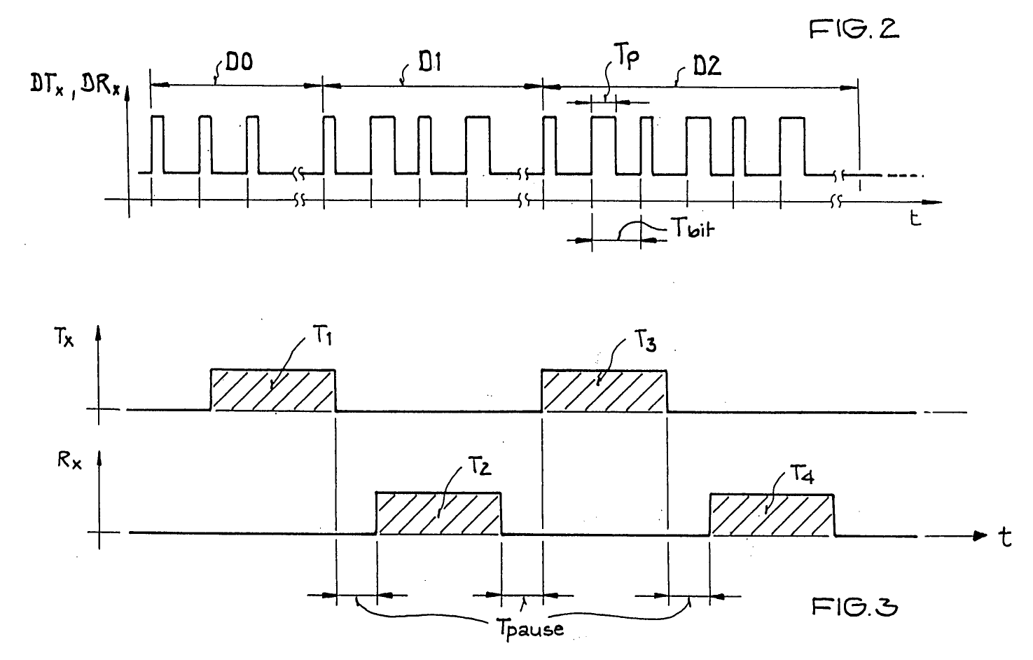

FIG. 2 shows a timing diagram of a data telegram transmitted from the transmitting and receiving station of FIG. 1,

FIG. 3 shows a timing diagram for depicting the course of communication between two transmitting and receiving stations as embodied in FIG. 1.

In accordance with FIG. 1 the transmitting and receiving station comprises a transmitting and receiving antenna ANT, a switch SW, a receiving arrangement R, a transmitting arrangement T, a crystal stable oscillator arrangement OSC, a counter MC, a register L, a digital control unit embodied as a microcontroller μC and a pulse width modulator PWM.

For implementing the method according to the invention two of the said transmitting and receiving stations are required. They are operated alternately in a transmitting or receiving mode, resp. In this connection the one transmitting and receiving station transmits in the transmitting mode a transmission signal Tx to the other transmitting and receiving station, which currently is operated in the receiving mode and which receives the transmission signal Tx after its delay on the transmission path as a received signal Rx.

The operating mode of the transmitting and receiving station is defined via the switch position of its switch SW and is controlled by the microcontroller μC.

In the transmitting operating mode the switch SW is located in the lower position shown in dashed lines. In this operating mode the pulse width modulator PWM produces from data D, which are provided by the microcontroller μC, a binary pulse width modulated transmission data signal DTx as per the indicator of a bit timing Tbit. A signal of this type is composed of a sequence of pulses with either equidistantly rising or equidistantly falling pulse edges, the pulses in their pulse duration containing the bit information, which is to be transmitted with the respective pulse. A pulse series of this type is referred to hereinafter as data telegram. In the present example of embodiment a narrow pulse corresponds to the bit information “0” and a wide pulse to the bit information “1” and the rising pulse edges are distanced to each other in the bit timing Tbit. Thus, the data bits are transmitted one after the other each after termination of a bit timing Tbit.

The transmission data signal DTx is subsequently modulated in the transmitting arrangement T to a carrier by amplitude keying and is conducted as a transmission signal Tx via the switch SW to the transmitting and receiving antenna ANT and is radiated from it as an electromagnetic wave. The carrier frequency ftx of the transmission signal Tx is provided here by the oscillator arrangement OSC as per the indicator of a control signal Ctrl emitted by the microcontroller μC. The oscillator arrangement OSC further provides also a time clock Tclk as a time basis for the counter MC, from which the counter MC derives the bit timing Tbit as a time distance between two counter overflows by counting the time clocks Tclk.

In the receiving operating mode the switch SW is located in the upper position. In this operating mode the received signal Rx received via the transmitting and receiving antenna ANT is routed via the switch SW to the receiver arrangement R and there, by amplification, mixture with a local oscillator frequency flo provided by the oscillator arrangement OSC, filtering and envelope demodulation is converted as a binary pulse width modulated receiver data signal DRx into the base frequency band. The receiver data signal DRx is then supplied to the microcontroller μC for extracting the bit information contained in it. Parallel hereto the receiver data signal DRx is supplied to the register L, which saves-the state of the counter MC at the time of receipt of each single data bit and which provides it to the microcontroller μC as a counter value Ci for further evaluation.

Within a communication cycle between the two transmitting and receiving stations in accordance with FIG. 3 at least three, preferably four data telegrams T1, T2, T3, T4 are transmitted. Between the individual data telegrams identical pauses Tpause are each observed.

The transmitted data telegrams are composed in accordance with FIG. 2 of three bit blocks each, namely of a leader D0, a starting block D1 and a data block D2. The leader D0 consists of a row of identical bits. Its object is to bring the receiver arrangement R into a stable operating state, e.g. by adjusting the signal level of the received signal Rx converted in an intermediate frequency region to a given signal level. The starting block D1 contains at least one bit and its object is to mark the beginning of the ensuing data block D2. The data block D2 finally contains the data bits to be actually transmitted. The number of the data bits can vary from data telegram to data telegram, in the following, however, it is presumed that all data telegrams contain the same number n of data bits in their data blocks.

The determination of the distance between the transmitting and receiving station is based on the determination of the signal running time of the data telegrams transmitted between the transmitting and receiving stations. The determination of the signal running time in turn is based on the evaluation of the time of receipt of the single data bits from the received signal Rx.

For detecting said times, in the transmitting and receiving station operated in the receiving mode the counter state of the counter MC is assumed into the register L with each rising pulse edge of the receiver data signal DRx, which marks the receipt of a data bit. The counter MC is clocked with a clock signal presetting the time clock Tclk and its counter state is increased here by one, respectively. After overflow of the counter state the counter MC starts to count from a counter state of zero. The frequency of the clock signals is approximately identical in both transmitting and receiving stations. The counter state assumed from the register L is released as a counter value Ci to the microcontroller μC for evaluation. In this way a time stamp is allocated to each receiving data bit at the rising pulse edge of the receiver data signal DRx, corresponding to the counter value Ci of the free running counter MC. The counter MC here acts as an internal clock of the concerned transmitting and receiving station. It can be reset for synchronization with the corresponding counter of the other transmitting and receiving station by the microcontroller μC via a reset line Reset.

The counter states of the counter MC from the two transmitting and receiving stations are referred to hereinafter as C_{A} and C_{B} and the corresponding counter values Cᵢ, determined at the receipt of the data bits, are referred to as C_{Ai} and C_{Bi}. The indices A and B indicate here that the concerned counter state C_{A} and C_{B}, and the concerned counter value C_{Ai} and C_{Bi}, has been determined in the first and second transmitting and receiving station, resp.

Generally, the two counter states C_{A} and C_{B} differ from each other, as the counter MC of the two transmitting and receiving stations run independently from each other. At a certain time a signed counter state offset ΔC₀=C_{A}−C_{B} is received as a difference, which, moreover, increases or decreases with each bit timing Tbit by a signed counting fault ΔC_{F}. This counting fault ΔC_{F} is caused by the time clocks Tclk in the two transmitting and receiving stations which are only approximately identical. The difference between the time clocks Tclk causes gaining or retarding of the counter MC of the one transmitting and receiving station in relation to the counter MC of the other transmitting and receiving station. The counting fault ΔC_{F} indicates here the by what amount the one counter MC gains or retards the other one per bit timing Tbit.

For eliminating these unknown differences—of the counter state offset ΔC₀ and of the counting fault ΔC_{F}—the method according to the invention provides that between the two transmitting and receiving stations at least three, preferably four data telegrams are exchanged and that for each data telegram the sum or the average value of the counter values determined during reception of the data telegram concerned is calculated and is made available in one of the two transmitting and receiving stations, which then calculates the distance.

The method is started by the first transmitting and receiving station with transmitting a first data telegram. The single bits of the data telegram are transmitted one after the other each at a zero point of the counter state C_{A}, i.e. transmission of the bits is performed synchronously to the bit timing Tbit produced in the first transmitting and receiving station.

The second transmitting and receiving station receives the first data telegram and resets its own counter MC during the leader. Consequently, the counters MC of the two transmitting and receiving stations are approximately synchronized, an exact synchronization is not necessary. Synchronization is done during the determination of the distance only once when receiving the first data telegram.

Then, in the second transmitting and receiving station during reception of the first data telegram for each received data bit the relating counter value C_{Bi} is determined and is saved in the microcontroller μC as a time stamp of the concerned data bit. For the i^{th} data bit one receives in this way as a counter value the value
C_{Bi}=ΔC₀+i·ΔC_{F}+ΔC_{SBi}. (1)

Here ΔC₀ stands for the initial counter state offset, ΔC_{F} for the counting fault caused by the different time clocks Tclk and ΔC_{SBi} for the counter state difference resulting from the signal running time. The data telegram contains in a total of n data bits. Thus, counter values ΔC_{B1}, ΔC_{B2}, . . . ΔC_{Bn}, are obtained, which are summed in the microcontroller μC to a first counter sum S₁. In this case the following applies

$${S}_{1} = {\sum }_{i = 1}^{n} {C}_{Bi} = - n \cdot Δ {C}_{0} + {\sum }_{i = 1}^{n} Δ {C}_{SBi} + \frac{n ( n + 1 )}{2} \cdot Δ {C}_{F} . \qquad ( 2 )$$

With the average value of the counter state difference dependent from the signal running time

$$Δ {\overline{C}}_{S} = \frac{1}{n} \cdot {\sum }_{i = 1}^{n} Δ {C}_{SBi} \qquad ( 3 )$$

the equation (2) simplifies to read

$${S}_{1} = n \cdot ( - Δ {C}_{0} + Δ \overline{C} + \frac{n ( n + 1 )}{2} \cdot Δ {C}_{F} ) \qquad ( 4 )$$

The second transmitting and receiving station responds to the receipt of the first data telegram with transmitting a second data telegram, which in the data block contains information on the first counter sum S₁. Between reception of the last data bit of the first data telegram and the transmission of the first data bit of the second data telegram here k bit timings Tbit pass by. They are counted with an additional counter, which for instance is provided in the microcontroller μC. In this way between reception of the first data bit of the first data telegram and transmission of the first data bit of the second data telegram approximately m=n+k bit timings Tbit pass by. This is approximately because the counting of the bit timings Tbit is related once to the counter MC of the one transmitting and receiving station and when changing the direction of transmission to the counter MC of the other transmitting and receiving station. As, however, both counters run only approximately synchronously, a non-integer pause of k bit timings is obtained. This fault remains unconsidered in the following. For the second data telegram one obtains, therefore, on the basis of the counting fault ΔC_{F} a counter state offset ΔC′₀, which is amended in relation to the initial counter state offset ΔC₀. It applies
ΔC′₀=C_{A}−C_{B}=ΔC₀+m·ΔC_{F} (5)

The single bits of the second data telegram are transmitted each with a zero point of the counter state C_{B}, i.e. synchronously to the bit timing Tbit of the second transmitting and receiving station. With reversion of the direction of transmission also the sign of the counting fault ΔC_{F} changes. Strictly speaking, also the amount of the counting fault ΔC_{F} changes dependent from which of the two transmitting and receiving stations the counting fault ΔC_{F} is observed, i.e. dependent whether one refers it to the counter state C_{A} or C_{B}. This small amount fault is neglected hereinafter.

In the first transmitting and receiving station then analogously as in the second transmitting and receiving station for each data bit of the second data telegram the relating counter value C_{Ai} is determined and is saved in the microcontroller μC as a time stamp of the data bit concerned. For the i^{th} data bit of the second data telegram one thus obtains as a counter value C_{Ai} the value
C_{Ai}=ΔC′₀+ΔC_{SAi}−i·ΔC_{F}. (6)

Again, n data bits are received and the counter values ΔC_{A1}, ΔC_{A2}, . . . ΔC_{An}, determined during reception of these data bits are summed to a second counter sum S₂. For the second counter sum S₂ one thus obtains:

$$\begin{matrix}{S}_{2} = {\sum }_{i = 1}^{n} {C}_{Ai} = - n \cdot Δ {C}_{0}^{′} + n \cdot Δ {\overline{C}}_{S} - \frac{n ( n + 1 )}{2} \cdot Δ {C}_{F} \\ = n \cdot ( Δ {C}_{0}^{′} + Δ {\overline{C}}_{S} - \frac{( n + 1 )}{2} \cdot Δ {C}_{F} )\end{matrix} \qquad ( 7 )$$

With the equation (5) this equation can be written also as follows:

$${S}_{2} = n \cdot [ Δ {C}_{0} + Δ {\overline{C}}_{S} + ( m - \frac{( n + 1 )}{2} ) \cdot Δ {C}_{F} ] . \qquad ( 8 )$$

Subsequently, the first and second counter sum S₁, S₂ are summed to a first intermediate sum S₁₂. From the equations (4) and (8) one then obtains:
S₁₂=S₁+S₂=n·(2·Δ\overline{C}_{S}+m·ΔC_{F}). (9)

This result is independent from the initial counter state offset ΔC₀. If the counting fault ΔC_{F} is known, for example it equals zero, from this equation the average value of the counter difference Δ\overline{C}_{S} dependent from the running time can be calculated without any problems as an indicator of the searched distance between the transmitting and receiving stations.

In general, however, the counting fault ΔC_{F} is not known. To eliminate this size from the result of measurement, a third data telegram is transmitted from the first transmitting and receiving station to the second transmitting and receiving station. This data telegram in turns contains n data bits, from which the first one is transmitted after a pause of k bit timings Tbit from reception of the last data bit of the second data telegram. Thus, for the third data telegram an amended counter state offset
ΔC″₀=C_{A}−C_{B}=ΔC₀+2·m·ΔC_{F} (10)
is obtained.

The third data telegram is transmitted in equal manner as the first data telegram, i.e. the single bits of the third data telegram are also transmitted each at a counter state C_{A}=0.

Then, in the second transmitting and receiving station as when transmitting the first data telegram during reception of the third data telegram for each received data bit the relating counter value C_{Bi} is determined and is saved in the microcontroller μC as a time stamp of the data bit concerned. For the i^{th} data bit of the third data telegram one then obtains with the equation (10) as a counter value C_{Bi} the value
ΔC_{Bi}=−C″₀+ΔC_{SBi}+i·ΔC_{F} (11)

The n counter values ΔC_{B}, . . . ΔC_{Bn}, determined during reception of the third data telegram are then summed to a third counter sum S₃. It applies:

$${S}_{3} = {\sum }_{i = 1}^{n} {C}_{Bi} = n \cdot ( - Δ {C}_{0}^{″} \cdot Δ {\overline{C}}_{S} + \frac{( n + 1 )}{2} \cdot Δ {C}_{F} ) \qquad ( 12 )$$

and with the equation (10) this results in:

$${S}_{3} = n \cdot [ - Δ {C}_{0} \cdot Δ {\overline{C}}_{S} + ( - 2 \cdot m + \frac{( n + 1 )}{2} \cdot Δ {C}_{F} ] . \qquad ( 13 )$$

Subsequently, the second and third counter sum S₂, S₃ are summed to a second intermediate sum S₂₃. From the equations (8) and (13) one thus obtains:
S₂₃=S₂+S₃=n·(2·Δ\overline{C}_{S}−m·ΔC_{F}) (14)

The first and second intermediate sum S₁₂, S₂₃ are now summed to a third intermediate sum S₁₂₃. From the equations (9) and (14) one then obtains:
S₁₂₃=S₁₂+S₂₃=S₁+2·S₂+S₃=4·n·Δ\overline{C}_{S} (15)

This intermediate sum S₁₂₃ is independent from the initial counter state offset ΔC₀ and thus also from the counting fault ΔC_{F}. As the number n of the transmitted data bits is known, from this equation the average value of the counter difference Δ\overline{C}_{S} dependent from the running time can be calculated without any problems as an indicator of the searched distance between the transmitting and receiving stations. One then obtains

$$Δ {\overline{C}}_{S} = \frac{{S}_{123}}{4 \cdot n} = \frac{{S}_{1} + 2 {S}_{2} + {S}_{3}}{4 \cdot n} \qquad ( 16 )$$

The division of the counter sums S₁, S₂, S₃ through the number n of the transmitted bit digits corresponds to an averaging of the counter states determined during reception of the respective data telegram.

With the known time clock Tclk now in the second transmitting and receiving station the signal running time τ can be calculated from the equation (16) as follows:

$$τ = Δ {\overline{C}}_{S} \cdot Tclk = \frac{Tclk}{4 \cdot n} = ( {S}_{1} + 2 {S}_{2} + {S}_{3} ) \qquad ( 17 )$$

If, however, the distance between the transmitting and receiving station is to be analyzed in the first transmitting and receiving station, a further data transmission must be performed, in order to provide the signal running time τ or the data required for calculating the signal running time τ of the transmitting and receiving station.

Advantageously, for this purpose a fourth data telegram is transmitted from the second transmitting and receiving station to the first one. This fourth data telegram contains as information the third counter sum S₃ determined in the second transmitting and receiving station. With the fourth data telegram in turn n data bits are transmitted, the first of these data bits being transmitted after a pause of ka bit timings Tbit from reception of the last data bit of the previous data telegram. Thus, one obtains for the fourth data telegram an amended counter state offset
ΔC′″₀=C_{A}−C_{B}=ΔC₀+3·m·ΔC_{F} (18)

The transmission of the fourth data telegram is performed in equal manner as the transmission of the second data telegram. The single bits of the fourth data telegram thus are also transmitted as the data bits of the second data telegram each at a counter state C_{A}=0.

In turn, in the first transmitting and receiving station for each received data bit the relating counter value C_{Ai} is determined and is saved in the microcontroller μC as a time stamp of the data bit concerned. For the i^{th} data bit of the fourth data telegram one then obtains with the equation (18) as a counter value C_{Ai} the value
ΔC_{Ai}=ΔC′″₀+ΔC_{SAi}−i·ΔC_{F} (19)

The n counter values ΔC_{A1}, . . . ΔC_{An}, determined during reception of the fourth data telegram are then summed to a fourth counter sum S₄. It applies:

$${S}_{4} = {\sum }_{i = 1}^{n} {C}_{4 i} = n \cdot ( Δ {C}_{0}^{″′} + Δ {\overline{C}}_{S} - \frac{n + 1}{2} \cdot Δ {C}_{F} ) \qquad ( 20 )$$

and with the equation (18) this results in:

$${S}_{4} = n \cdot [ Δ {C}_{0} + Δ {\overline{C}}_{S} + ( 3 \cdot m - \frac{n + 1}{2} ) \cdot Δ {C}_{F} ] \qquad ( 21 )$$

Subsequently, the third and fourth counter sum S₃, S₄ are summed to a fourth intermediate sum S₃₄
S₃₄=S₃−S₄=n·(2·Δ\overline{C}_{S}+m·ΔC_{F}) (22)
the second and fourth intermediate sum S₂₃, S₃₄ are added to a fifth intermediate sum S₂₃₄
S₂₃₄=S₂₃+S₃₄=4·n·Δ\overline{C}_{S} (23)
the third and fifth intermediate sum S₁₂₃, S₂₃₄ are added to a sum number S_{S}
S_{S}=S₁₂₃+S₂₃₄=8·n·Δ\overline{C}_{S} (24)

For the signal running time τ it then applies:

$$τ = Δ {\overline{C}}_{S} \cdot Tclk = \frac{Tclk}{8 \cdot n} {S}_{S} \qquad ( 25 )$$

The sum number S_{S} thus is an indicator for the signal running time τ of the signals transmitted between the transmitting and receiving stations and based on the proportionality between the signal running time τ and the distance between the transmitting and receiving stations is also an indicator of this distance. It can be calculated from the counter sums S₁, S₂, S₃, S₄ also by weighted summation as follows:
S_{S}=S₁+3·S₂+3·S₃+S₄. (26)

Consequently, the equation (25) can be rewritten into

$$τ = Tclk \cdot [ \frac{1}{8} \cdot ( \frac{{S}_{1}}{n} + 3 \frac{{S}_{2}}{n} + 3 \frac{{S}_{3}}{n} + \frac{{S}_{4}}{n} ) ] \qquad ( 27 )$$

With the abbreviation

$${\overline{C}}_{i} = \frac{Si}{n} \qquad ( 28 )$$

for the average value of those counter values Cᵢ, which form the basis of the i^{th} counter sum Sᵢ, one obtains

$$τ = Tclk \frac{{\overline{C}}_{1} + 3 {\overline{C}}_{2} + 3 {\overline{C}}_{3} + {\overline{C}}_{4}}{8} \qquad ( 29 )$$

This equation is true if in both directions the same number n of data bits is transmitted. If this condition is not true, the factors, with which the average values \overline{C}₁, \overline{C}₂, \overline{C}₃, \overline{C}₄ are weighted, are to be adapted accordingly.

In the present example of embodiment the measurement method terminates after transmission of the fourth data telegram. However, it can be extended in that more than four data telegrams of the distance determination or determination of the signal running time can form the basis. The equations for the i^{th} counter sum Sᵢ and the i^{th} average value \overline{C}₁ can then be generalized as follows:

$$\begin{matrix}{S}_{i} = n \cdot [ {( - 1 )}^{i} \cdot Δ {\overline{C}}_{0} + Δ {\overline{C}}_{S} + {( - 1 )}^{i} ( ( i - 1 ) \cdot m - \frac{n + 1}{2} ) ] \cdot Δ {\overline{C}}_{S} & ( 30 ) \\ {\overline{C}}_{i} = \frac{Si}{n} = [ {( - 1 )}^{i} \cdot Δ {\overline{C}}_{0} + Δ {\overline{C}}_{S} + {( - 1 )}^{i} ( ( i - 1 ) \cdot m - \frac{n + 1}{2} ) ] \cdot Δ {\overline{C}}_{s} & ( 31 )\end{matrix}$$

If the determination of the signal running time is to be performed on the basis of j data telegrams, the equation (29) is to be modified as follows:

$$τ = Tclk \frac{{g}_{1} \cdot {\overline{C}}_{1} + {g}_{2} \cdot {\overline{C}}_{2} + ⋯ + {g}_{j} \cdot {\overline{C}}_{j}}{{g}_{1} + {g}_{2} + ⋯ + {g}_{j}} = \qquad ( 32 )$$

Here, g₁, g₂, . . . gⱼ are weighting factors, with which the respective average value \overline{C}₁ or \overline{C}₂ or \overline{C}ⱼ is weighted. The weighting factors g₁, g₂, . . . gⱼ are to be chosen such that the signal running time τ is independent from the counter state offset ΔC₀ and from the counting fault ΔC_{F}. This condition is met, if the row of the weighting factors g₁, g₂, . . . gⱼ is equal to a row of so-called binominal coefficients, i.e. if for the i^{th} weighting factors g₁ it applies:

$${g}_{i} = ( \frac{j - 1}{i - 1} ) = \frac{( j - 1 ) !}{( i - 1 ) ! \cdot ( j - 1 ) !} \qquad ( 33 )$$

For the sum of the weighting factors g₁, g₂, . . . gⱼ it applies:
g₁+g₂+ . . . gⱼ=2^{j-1} (34)

If all data telegrams forming the basis for determination of the distance comprise the same number n of data bits, the equation (32) with the equations (28) and (34) can be transformed as follows:

$$τ = Tclk \frac{{g}_{1} \cdot {S}_{1} + {g}_{2} \cdot {S}_{2} + ⋯ + {g}_{j} \cdot {S}_{j}}{n \cdot ( {g}_{1} + {g}_{2} + ⋯ + {g}_{j} )} = Tclk \frac{{S}_{S}}{n \cdot {2}^{j - 1}} \qquad ( 35 )$$

Thus, also when evaluating more than four data telegrams the signal running time τ is proportional to the sum number S_{S}, which according to the equation
S_{S}=g₁·S₁+g₂·S₂+ . . . +gᵢ·Sⱼ (36)
can be calculated by weighted summation from the counter sums S₁, S₂, . . . Sⱼ and the binominal coefficients g₁, g₂, . . . gⱼ.

The signal running time τ is composed of the running time on the path of transmission (go and return) and from group running times in the components of the transmitting and receiving stations. The group running times can be measured so that from the detected signal running time τ the running time on the path of transmission and from it the distance between the transmitting and receiving stations can be calculated.

The method according to the invention is particularly suitable for use in a keyless locking system for motor vehicles. With a locking system of this type a base station is provided in the motor vehicle as an evaluation unit, which communicates with portable key modules via a radio link. The radio link between the base station and a key module is established via two transmitting and receiving stations shown in FIG. 1. These are components of the base station and the key module communicating with the base station, resp. Here, the radio link can be established without being noticed by the authorized user for example by operating a door handle. Via the radio link data telegrams with data are exchanged, in particular the counter sums determined in the transmitting and receiving station of the key module as well as an identification number saved in the key module are transmitted to the base station. The transmission of the identification number is performed preferably in coded form. The base station evaluates the identification number and calculates from counter sums existing in it the distance to the key module. Subsequently, it releases the motor vehicle for use, if it recognizes on the basis of the identification number that an authorization to gain access is allocated to the key module, and if the key module is located with in a certain distance to the base station.

By taking into consideration the distance, security of the locking system is increased, as the access to the motor vehicle is prevented also with a correct identification number, if the radio link between the key module and the base station is established via relay stations by unauthorized persons, without being noticed by the authorized user.

1. A method for determining the distance between two transmitting and receiving stations, which communicate with each other by transmitting data telegrams comprising at least one data bit, characterized in that
at least three data telegrams are transmitted alternately between the transmitting and receiving stations
to each data bit of the at least three data telegrams during reception of the data telegram concerned a counter value (C_{Ai}, C_{Bi}) is allocated, which corresponds to the counter state of a free-running counter (MC) at the time of reception of the respective data bit,
to each of the at least three data telegrams a counter sum (S₁, S₂, S₃, . . . Sⱼ) is allocated, which corresponds to the sum or the average value of the counter values (C_{Ai}, C_{Bi}) determined during reception of the data telegram concerned,
and a sum number (S_{S}) is formed by weighted summation of the counter sums (S₁, S₂, S₃, S₄) as an indicator of the distance between the transmitting and receiving stations.

2. A method according to claim 1, characterized in that for determining the sum number (S_{S}) the counter sums (S₁, S₂, S₃, . . . Sⱼ) are weighted with a binomial coefficient which corresponds to their sequence.

3-11. (canceled)

12. A method according to claim 1, characterized in that informations on the counter sums (S₁, S₃) determined in the one transmitting and receiving station are transmitted as data telegrams to the other transmitting and receiving station.

13. A method according to claim 1, characterized in that four data telegrams are evaluated for determining the distance.

14. A method according to claim 1, characterized in that the data telegrams each comprise the same number of data bits.

15. A method according to claim 1, characterized in that a pause of a given duration is observed between the transmitted data telegrams.

16. A transmitting and receiving station for carrying out the method according to claim 1, with
a transmitting and receiving antenna (ANT) for receiving the received signal (Rx) and for transmitting a transmission signal (Tx),
a receiver arrangement (R) for converting the frequency of the received signal (Rx) and for detecting data bits from the received signal (Rx),
a transmitting arrangement (T) for producing the transmission signal (Tx) from a sequence of data bits to be transmitted at a given bit timing (Tbit),
a counter (MC) clocked at a given time clock (Tclk) for producing the bit timing (Tbit) as time distance between successive counter state overflows,
a register (L) for taking over the counter state of the counter (MC) each at the time of reception of a data bit and for providing the assumed counter state as counter value (Cᵢ).

17. A transmitting and receiving station according to claim 16, characterized in that a pulse width modulator (PWM) clocked as per the indicator of the bit timing (Tbit) is provided for producing a binary transmitting data signal (DTx) from the data bits to be transmitted and in that the transmitting data signal (DTx) is supplied to the transmitting arrangement (T) for producing the transmission signal (Tx).

18. A transmitting and receiving station according to claim 16, characterized in that a switch (SW) is provided, via which the transmitting and receiving antenna (ANT) is conductively connected alternatively with the receiver arrangement (R) or with the transmitting arrangement (T).

19. A transmitting and receiving station according to claim 16, characterized in that a digital control unit, in particular a microcontroller (μC) is provided for evaluating the counter values (Cᵢ) and for providing the bit information to be transmitted.

20. Use of the method according to claim 1, in a keyless locking system for motor vehicles for determining the distance between a first transmitting and receiving station provided in the motor vehicle and a second transmitting and receiving station provided in a key module.
